(19) United States
(12) Patent Application Publication
(10) Pub. No.: US 2002/0012046 A1
(43) Pub. Date: Jan. 31, 2002

(54) Image reader and method of controlling the same

(76) Inventor: Shigeki Ishino, Kawasaki-shi (JP)

Correspondence Address: MORGAN, LEWIS & BOCKIUS, 1800 M STREET NW, WASHINGTON, DC, 20036-5869, US

(21) Appl. No.: 09/866,986

(22) Filed: May 30, 2001

(30) Foreign Application Priority Data
Jun. 5, 2000 (JP) 2000-168121

(51) Int. Cl. H04N 5/253; H04N 9/47

(52) U.S. Cl. 348/96

(57) ABSTRACT

The network system is configured to execute communications between a management server and plural scanners by using the http, whereby the management server is able to execute the operation instructions to the scanners. Thus, the invention provides an image reader that achieves to enhance operability and controllability, utilizing the conditions of the image readers being connected to the network.

### BACKGROUND OF THE INVENTION

1. Field of the Invention

The present invention relates to an image reader and a method of controlling the same, specifically to an image reader connected to a network, which receives control instructions and transfers images through the network, and the method of controlling the same.

2. Description of the Related Art

Accompanied with the recent advancement of the network technology, image readers such as scanner have been developed to exhibit a better interface with the network, and they have been utilized in various fields. For example, plural clients connected to a network share a scanner, or a scanner is combined with a printer to configure a duplicating system; such ideas and trials have actively been practiced.

Further, unique techniques that connect the scanner to the network have been developed for practical use.

For example, in the image input/output device being disclosed in the Japanese Published Unexamined Patent Application No. Hei 11-215331, the storage location of document image data read by a scanner is informed to a transfer address, and in the distributed duplicating system being disclosed in the Japanese Published Unexamined Patent Application No. Hei 7-160152, a single command enables operations of plural devices being distributed on the network.

However, the conventional image readers transmit images read out or transmit information of the operation state, but it is difficult to say that the scanner takes full advantage of being connected to the network.

### SUMMARY OF THE INVENTION

The present invention has been made in view of the above circumstances and provides an image reader that achieves to enhance operability and controllability, utilizing the conditions of the image readers being connected to the network.

According to one aspect of the invention, the image reader connected to a network, which is managed by a management device connected to the network, includes an operation instruction receiving part that receives an operation instruction from the management device, and a reading part that reads an image on the basis of the operation instruction received by the operation instruction receiving part.

The image reader may further include a display operation part that displays information and receives an operation instruction. The reading part reads the image on the basis of the operation instruction received by the operation instruction receiving part, or the operation instruction received by the display operation part.

The image reader may alternatively include an image transfer part that transfers the image read by the reading part to the management device.

The image reader may still alternatively include a storage part that stores the image read by the reading part.

In the image reader, the display operation part may include a browser part that displays a Web page and receives an instruction to input information into the Web page.

The display operation part may acquire an operation instruction page supplied from the management device, and display the acquired operation instruction page.

The reading part may read the image in accordance with the operation instruction that the management device issues on the basis of a parameter defined by the operation instruction page.

The operation instruction page may permit to designate an instruction that reads one document plural times continuously by using different parameters.

The image reader may alternatively include a Web server part that supplies the Web page to the display operation part and a Web client connected to the network.

The display operation part may acquire a first operation instruction page supplied from the management device, acquire a second operation instruction page supplied by the Web server part, and display the acquired first and second operation instruction pages.

In the image reader, when there occurs a failure, the Web server part may supply the display operation part with a failure information page to inform that the failure has occurred.

The Web server part may supply the display operation part or the Web client with a control page that receives a control instruction including a shutdown of a power supply, and execute the control instruction received through the control page.

According to another aspect of the invention, a method of controlling an image reader connected to a network, which is managed by a management device connected to the network, issues an operation instruction to the image reader from the management device.

Alternatively, the method may issue an operation instruction to the image reader from the image reader or the management device.

The method may also operate the management device as a first Web server and operate the image reader as a Web client. The first Web server issues the operation instruction on the basis of the operation instruction received from the Web client.

The method may also operate the image reader as a second Web server. The second Web server displays control information received through the network and executes a control instruction.

The Web client may display Web pages supplied from the first Web server and the second Web server, and transmit a control instruction specified by the Web pages to the first Web server or the second Web server.

### BRIEF DESCRIPTION OF THE DRAWINGS

Preferred embodiments of the present invention will be described in detail based on the followings, wherein:

FIG. 1 is a chart illustrating a configuration of a network system including a scanner, to which the present invention is applied;

FIG. 2 is a block diagram illustrating a configuration of a scanner and a display device 3;

FIG. 3 is a chart illustrating the flow of operation instructions and image data;

FIGS. 4A and 4B illustrate a display image example (1) that is presented to a display unit;

FIG. 5 is a chart illustrating a display image example (2) that is presented to the display unit;

FIG. 6 is a flowchart illustrating the operational flows when the display unit presents an operation instruction screen;

FIG. 7 illustrates an operation example when there is an error in the setting at the display unit;

FIG. 8 is a chart illustrating an operation example when a management server acquires a state of the scanner;

FIG. 9 is a chart illustrating an operation example when the management server executes the power supply control of the scanner;

FIG. 10 is a chart illustrating an operation example during reading a document;

FIG. 11 is a chart illustrating another operation example during reading a document;

FIG. 12 is a chart illustrating an operation example during reading a document and transferring image data to the management server;

FIG. 13 is a chart illustrating an operation example when there occurs an abnormality in the scanner; and

FIG. 14 is a chart illustrating another operation example when there occurs an abnormality in the scanner.

### DETAILED DESCRIPTION OF THE PREFERRED EMBODIMENTS

One embodiment of an image reader and a method of controlling the same relating to the invention will be described in detail with reference to the accompanying drawings.

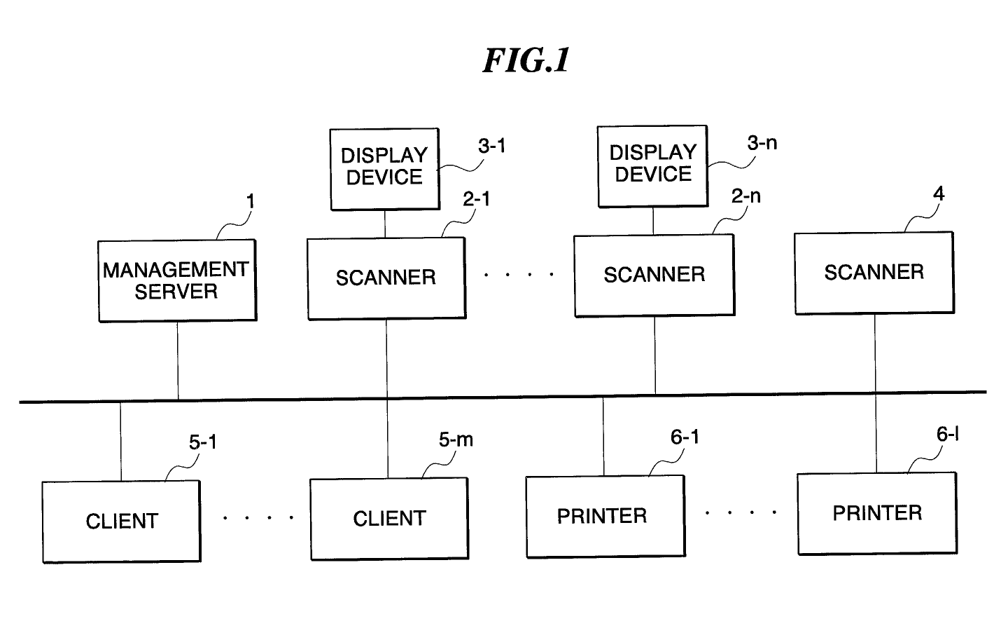

FIG. 1 illustrates a configuration of a network system including a scanner, having the invention applied thereto.

In the drawing, the network system includes a server 1, a scanner 2 (2-1 through 2-n), a display device 3 (3-1 through 3-n) connected to the scanner 2, a scanner 4, a client 5 (5-1 through 5-m), and a printer 6 (6-1 through 6-1). Here, the scanner 4 has the same construction as what the scanner 2 is combined with the display device 3, which does not possess a substantial difference.

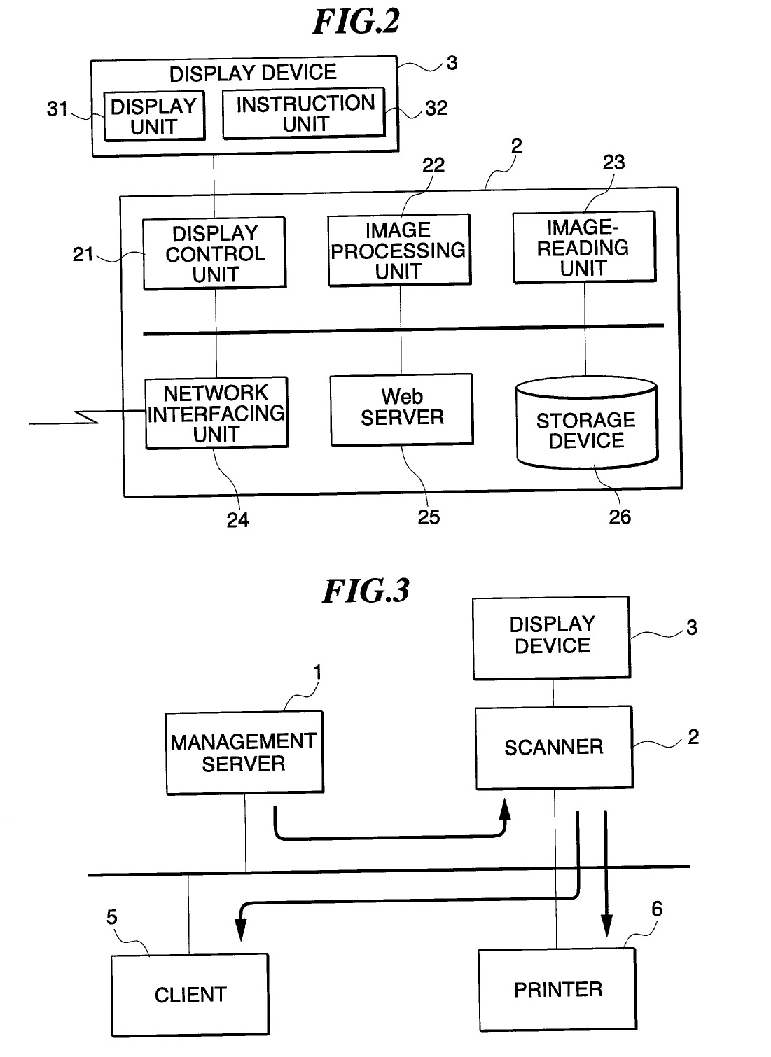

In the configuration of the scanner 2 and the display device 3 as illustrated in FIG. 2, the scanner 2 includes a display control unit 21, an image processing unit 22, an image-reading unit 23, a network interfacing unit 24, a Web server 25, a storage device 26; and the display device 3 includes a display unit 31 and an instruction unit 32.

In the scanner 2, the image-reading unit 23 reads a document to produce image data, to which the image processing unit 22 applies a specific processing, and the storage device 26 stores the result. Here, the storage location of the image data is not limited to the storage device 26, and it may be the management server 1 or the client 5 connected to the network through the network interfacing unit 24. Or, the image data may be directly transferred to the printer 6 to make print output.

Further, the display unit 31 operates as the Web browser, and acquires a Web page that the Web server 25 or the management server 1 provides through the display control unit 21 to display, and responds to inputting information and instructions from the instruction unit 32.

Here, naturally the scanner 2 operates directly in response to the operation instructions from the instruction unit 32, and as shown in FIG. 3, it also operates in accordance with the instructions from the management server 1 to output the image data to the client 5 and the printer 6. Therefore, when making the management server 1 operate as the Web server, the network system executes to send and receive information between the display unit 31 as the Web browser and the management server 1 as the Web server, so that the system can transfer the operation instruction from the instruction unit 32 to the scanner 2 through the management server 1. And, with this configuration, the system is able to share the operation instruction screen (user interface) displayed on the display unit 31 by the plural scanners 2, and to provide it from the management server 1.

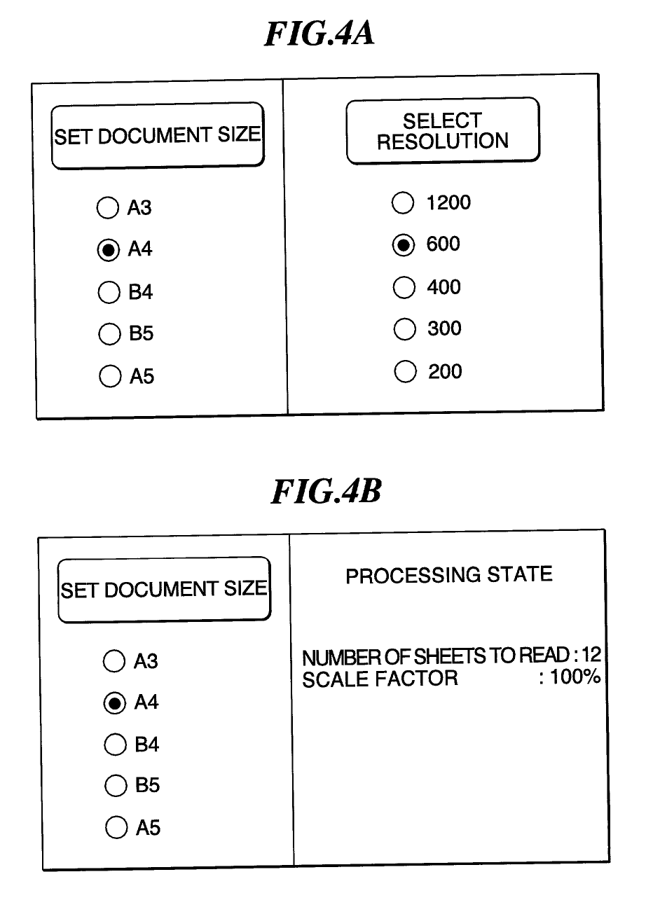

The system may provide the display image presented on the display unit 31 all from the management server 31, but it can provide the display image from the Web server 25 as well. For example, as shown in FIG. 4A, the system serves the left half of the display image as the common setting to all the scanners 2-1 through 2-n, and provides it from the management server 1; and the system serves the right half as the unique setting to the scanner 2, and provides it from the Web server 25. Further, when the scanner 2 starts reading a document, as shown in FIG. 4B, the system is able to make the Web server 25 provide the processing state of reading the document to display.

Since the operation instruction screen presented on the display unit 31 is formed as a Web page, it can easily be made and modified; and as shown in FIG. 5, for example, it is easy to produce the operation instruction screen that sets the reading of the same document by plural parameters.

When the system provides the operation instruction screen presented on the display unit 31 from the management server 1, if there is a network error or the management server 1 goes down, it will be impossible to operate the scanner 2, but in this case, the Web server 25 will provide the operation instruction screen to the display unit 31 by itself.

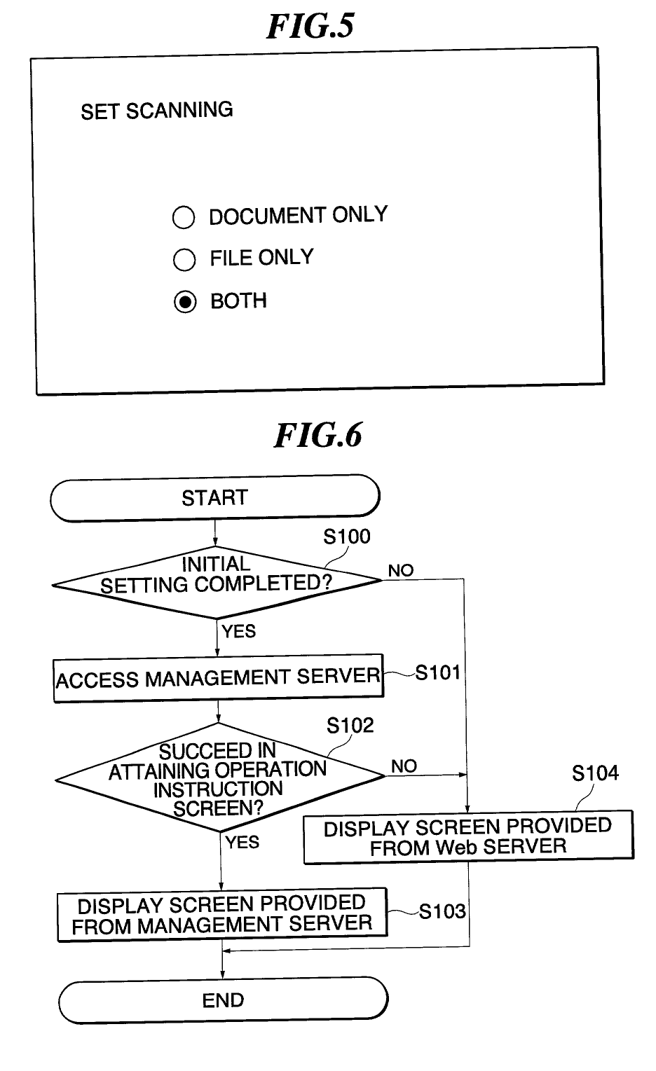

FIG. 6 illustrates the operational flows when the display unit 31 presents an operation instruction screen.

In the state where the initial setting for accessing the management server 1 is completed (Yes at step 100), if the display unit 31 accesses the management server 1 (step 101) and succeeds in attaining the operation instruction screen (Yes at step 102), the display unit 31 will present the operation instruction screen provided from the management server 1 (step 103).

On the other hand, if the initial setting for accessing the management server 1 is not carried out (No at step 100), or if the display unit 31 fails in attaining the operation display image (No at step 102), the display unit will present the operation instruction screen provided from the Web server 25 (step 104).

Here, the initial setting for accessing the management server 1 is a designation of the address of the management server 1, and normally there is no designation on factory shipments of the scanner 2.

Thus, the scanner 2 sends and receives information and instructions among the display unit 31, the management server 1, and the Web server 25, in this communication is basically used the http (hypertext transport protocol), and in some cases is used the CGI (Common Gateway Interface) as needed, that starts a specific program. And, when displaying the image data stored in the storage device 26, the display unit 31 uses the http for the communication to thereby eliminate the necessity of holding the function for accessing files.

Next, the flows of information and instructions and the flows of the operations of the relevant units will be described with plural operation examples of the scanner 2.

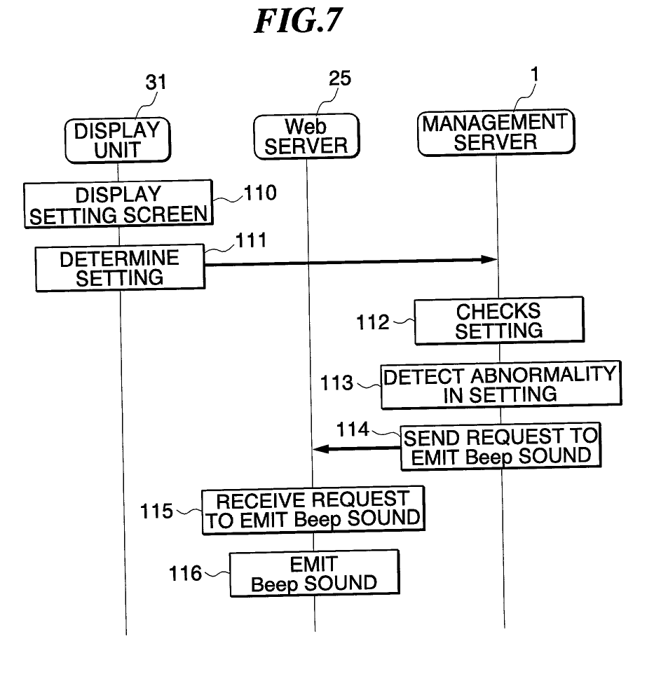

FIG. 7 illustrates an operation example when there is an error in the setting at the display unit 31.

First, the display unit 31 displays a setting image (step 110), and as the user determines the setting (step 111), the setting is transmitted to the management server 1.

The management server 1 checks the received setting (step 112), and if it detects an abnormality in the setting (step 113), the management server 1 will send a request to emit the Beep sound to the Web server 25 (step 114). On receiving this request (step 115), the Web server 25 emits the Beep sound (step 116) to prompt the user to pay attention.

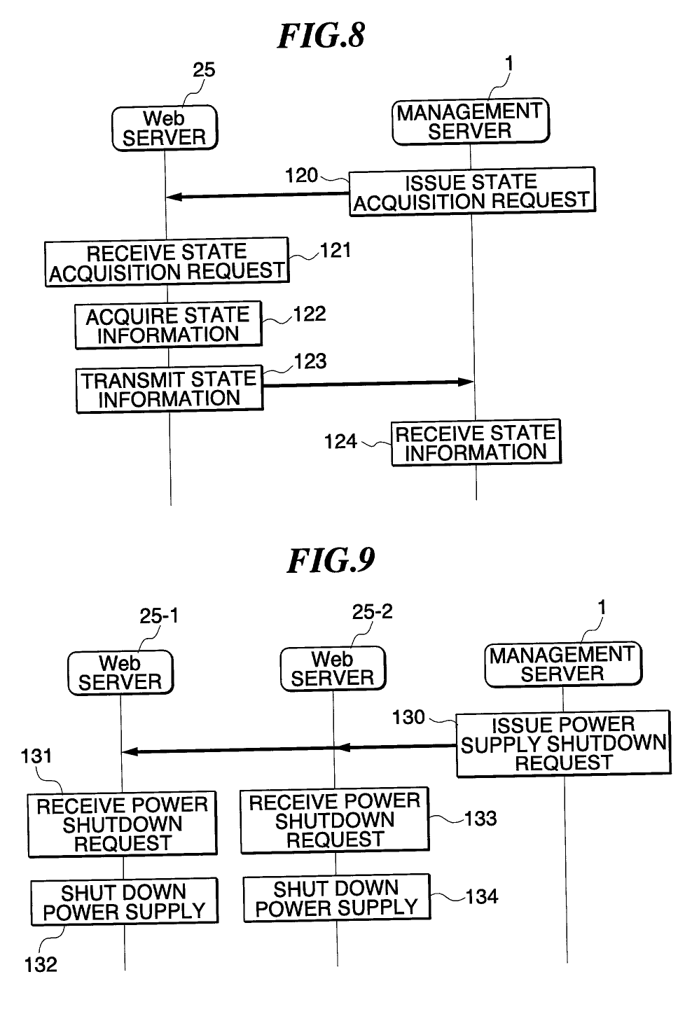

FIG. 8 illustrates an operation example when the management server 1 acquires the state of the scanner 2.

First, the management server 1 issues a state acquisition request to the Web server 25 (step 120); and on receiving this request (step 121), the Web server 25 acquires state information of the units of the scanner 2 (step 122), and transmits the acquired state information to the management server 1 (step 123). Receiving the state information (step 124), the management server 1 uses this information for the management of the scanner 2.

It is possible for the management server 1 to execute the device setting of the scanner 2, in accordance with the same procedure as what has been explained.

FIG. 9 illustrates an operation example when the management server 1 executes the power supply control of the scanner 2. The power supply control of the scanner 2 is effective in, for example, shutting down the power supply of the scanners 2-1 through 2-n all at once.

In executing the power supply control, the management server 1 issues a power supply shutdown request to the Web servers 25-1, 25-2 of the scanners 2-1, 2-2, for example (step 130). On receiving the power shutdown request (step 131, step 133), the Web server 25-1 and the Web server 25-2 each shut down the power supply (step 132, step 134).

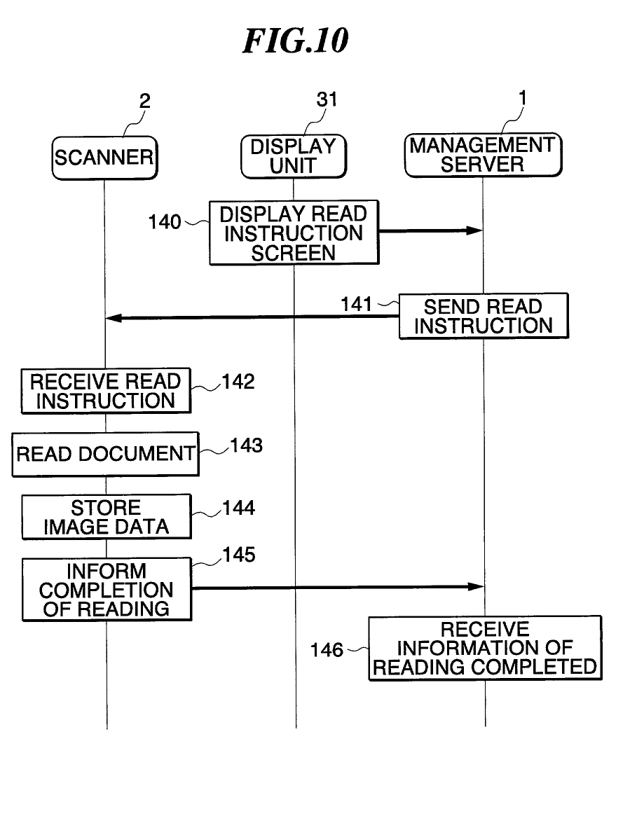

FIG. 10 illustrates an operation example during reading a document.

First, a read instruction screen is displayed on the display unit 31 (step 140). As the user operates to send the read instruction to the management server 1 (step 141), the management server 1 issues the read instruction of the document to the scanner 2 (step 142).

In the scanner 2 that receives the read instruction of the document, the image-reading unit 23 reads the document (step 143), the image processing unit 22 applies specific processing to the image data acquired by the read, and the storage device 26 stores the result (step 144). Thereafter, the scanner informs the management server 1 that the read of the document is completed (step 145, step 146).

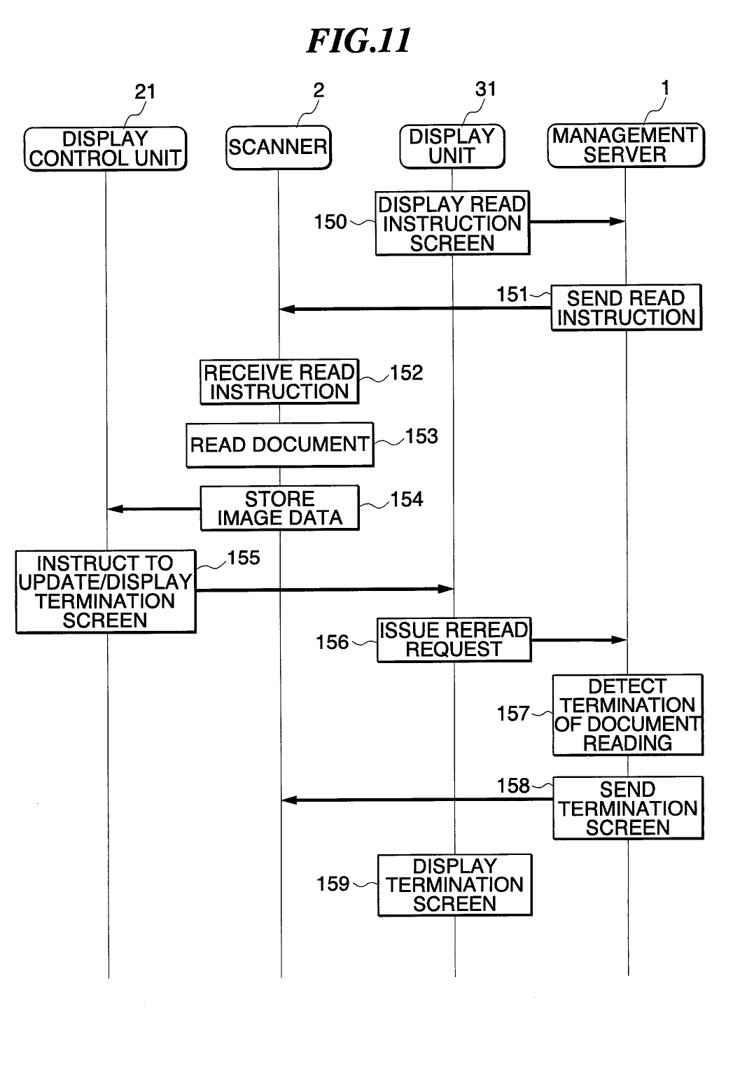

FIG. 11 illustrates another operation example during reading a document.

First, the read instruction screen is displayed on the display unit 31 (step 150). As the user operates to send the read instruction to the management server 1 (step 151), the management server 1 issues the read instruction of the document to the scanner 2 (step 152).

In the scanner 2 that receives the read instruction of the document, the image-reading unit 23 reads the document (step 153), the image processing unit 22 applies specific processing to the image data acquired by the read, and the storage device 26 stores the result (step 154). Thereafter, the display control unit 21 instructs the display unit 31 to display a termination screen by updating the display image (step 155), and the display unit 31 receiving this issues a reread request to the management server 1 (step 156).

The management server 1 detects the termination of the document read by the reread request (step 157) and sends the termination screen to the display unit 31 (step 158), and the display unit 31 displays the termination screen (step 159).

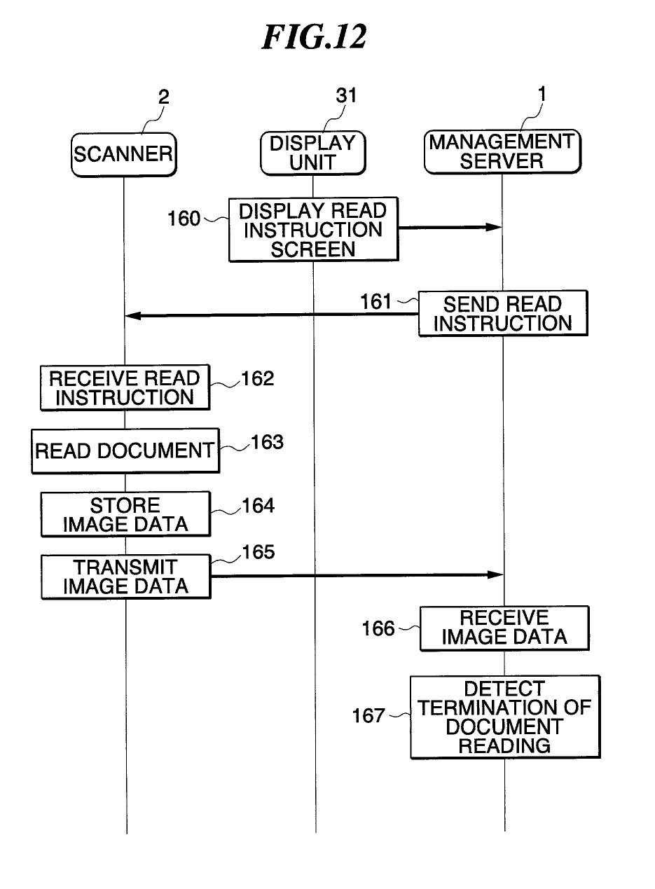

FIG. 12 illustrates an operation example during reading a document and transferring image data to the management server 1.

First, the read instruction screen is displayed on the display unit 31 (step 160). As the user operates to send the read instruction to the management server 1 (step 161), the management server 1 issues the read instruction of the document to the scanner 2 (step 162).

In the scanner 2 that receives the read instruction of the document, the image-reading unit 23 reads the document (step 163), the image processing unit 22 applies specific processing to the image data acquired by the read, and the storage device 26 stores the result (step 164). Thereafter, the scanner 2 sends the image data to the management server 1 (step 165), and the management server 1, receiving the image data (step 166), detects this to be the termination of the document read (step 167).

For the transfer of the image data from the scanner 2 to the management server 1, the ftp (file transfer protocol) may also be used in addition to the http.

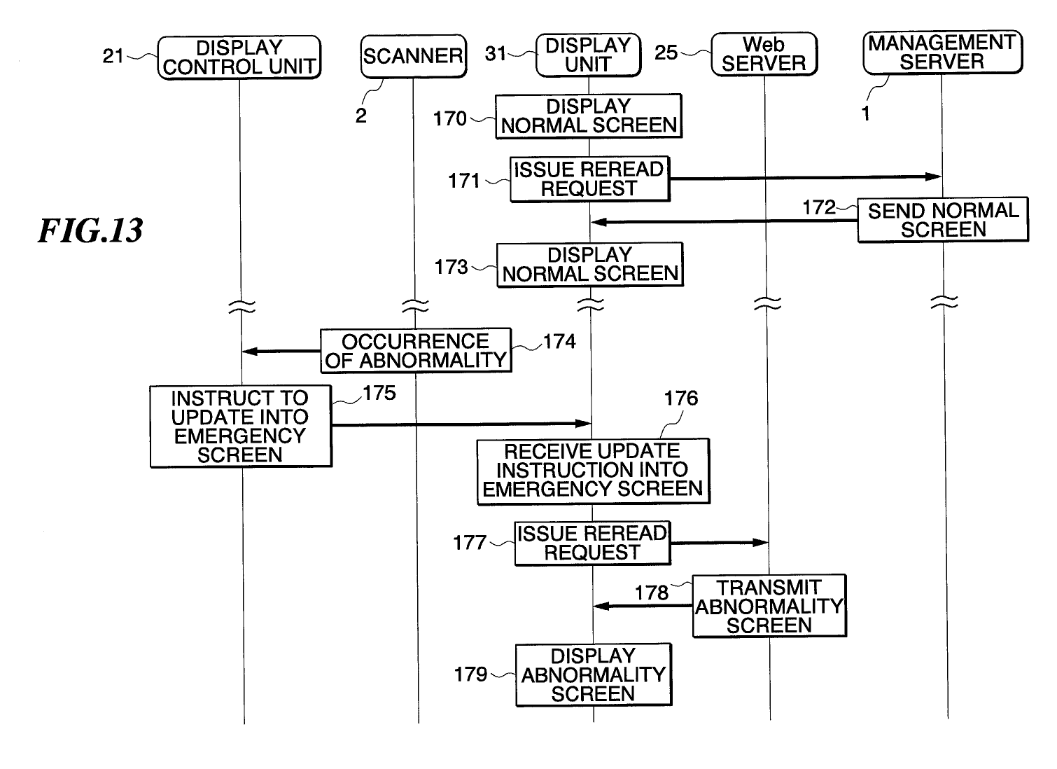

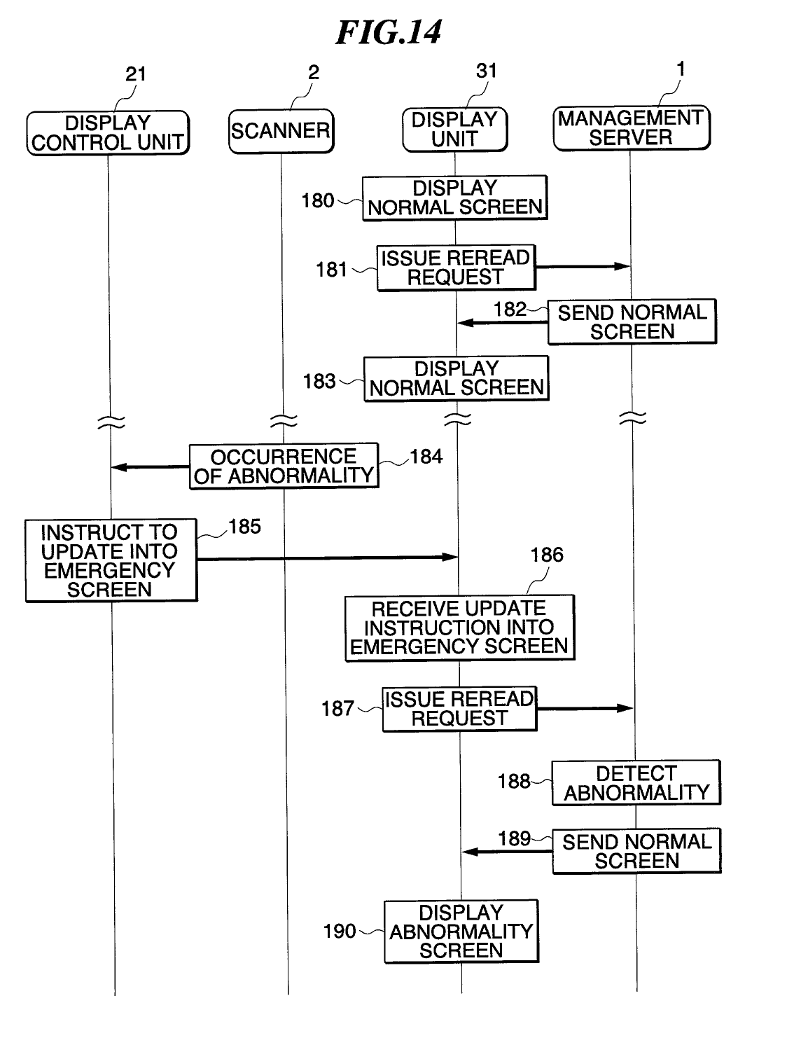

FIG. 13 illustrates an operation example when there occurs an abnormality in the scanner 2.

Before there occurs an abnormality in the scanner 2, the display unit 31 displays a normal screen (step 170). To display the normal screen, the display unit 31 periodically issues the reread request to the management server 1 (step 171), and displays the normal screen again that the management server 1 sends in response to this request (step 172, step 173).

Next, when there occurs an abnormality in the scanner 2 (step 174), the display control unit 21 issues an instruction to update the display image into an emergency screen to the display unit 31 (step 175). The display unit 31 receiving the update instruction into the emergency screen (step 176) issues the reread request of the image to the Web server 25 (step 177), and displays the emergency screen that the Web server 25 transmits in response to this request (step 178, step 179).

FIG. 14 illustrates another operation example when there occurs an abnormality in the scanner 2.

Before there occurs an abnormality in the scanner 2, the display unit 31 displays a normal screen (step 180). To display the normal screen, the display unit 31 periodically issues the reread request to the management server 1 (step 181), and displays the normal screen again that the management server 1 sends in response to this request (step 182, step 183).

Next, when there occurs an abnormality in the scanner 2 (step 184), the display control unit 21 issues an instruction to update the display image into the emergency screen to the display unit 31 (step 185). The display unit 31 receiving the update instruction into the emergency screen (step 186) issues the reread request of the image to the management server 1 (step 187), whereby the management server 1 detects that the scanner 2 is in emergency (step 188). Then, the management server 1 transmits the emergency screen to the display unit 31 (step 189), and the display unit 31 displays the emergency screen (step 190).

Further, there are many more modes of exchanging information and transferring instructions between the scanner 2 and the management server 1 than the operation examples described above.

As described above, the network system of the invention employs the http between the management server and the scanner to perform the communications, whereby the system is able to issue the operation instructions to the scanner from the management server; and therefore, the system is able to carry out the settings and controls to plural scanners all at once.

Further, when there occurs any emergency in the scanner, since the system is configured to inform the emergency from the scanner to the management server, the management server is released from periodical polling to the scanners, thus contributing to reducing loads to the network.

The entire disclosure of Japanese Patent Application No. 2000-168121 filed on Jun. 5, 2000 including specification, claims, drawings and abstract is incorporated herein by reference in its entirety.

What is claimed is:

1. An image reader connected to a network, which is managed by a management device connected to the network, the image reader comprising:
an operation instruction receiving part that receives an operation instruction from the management device; and
a reading part that reads an image on the basis of the operation instruction received by the operation instruction receiving part.

2. The image reader according to claim 1, further comprising:
a display operation part that displays information and receives an operation instruction, wherein the reading part reads the image on the basis of the operation instruction received by the operation instruction receiving part, or the operation instruction received by the display operation part.

3. The image reader according to claim 2, further comprising:
an image transfer part that transfers the image read by the reading part to the management device.

4. The image reader according to claim 2, further comprising:
a storage part that stores the image read by the reading part.

5. The image reader according to claim 2, wherein the display operation part comprises a browser part that displays a Web page and receives an instruction to input information into the Web page.

6. The image reader according to claim 5, wherein the display operation part acquires an operation instruction page supplied from the management device, and displays the acquired operation instruction page.

7. The image reader according to claim 6, wherein the reading part reads the image in accordance with the operation instruction that the management device issues on the basis of a parameter defined by the operation instruction page.

8. The image reader according to claim 6, wherein the operation instruction page permits to designate an instruction that reads one document plural times continuously by using different parameters.

9. The image reader according to claim 5, further comprising a Web server part that supplies the Web page to the display operation part and a Web client connected to the network.

10. The image reader according to claim 9, wherein the display operation part acquires a first operation instruction page supplied from the management device, acquires a second operation instruction page supplied by the Web server part, and displays the acquired first and second operation instruction pages.

11. The image reader according to claim 9, wherein, when there occurs a failure, the Web server part supplies the display operation part with a failure information page to inform that the failure has occurred.

12. The image reader according to claim 9, wherein the Web server part supplies the display operation part or the Web client with a control page that receives a control instruction including a shutdown of a power supply, and executes the control instruction received through the control page.

13. A method of controlling an image reader connected to a network, which is managed by a management device connected to the network, the method comprising:
issuing an operation instruction to the image reader from the management device.

14. The method of controlling an image reader according to claim 13, comprising:
issuing an operation instruction to the image reader from the image reader or the management device.

15. The method of controlling an image reader according to claim 14, comprising:
operating the management device as a first Web server and operating the image reader as a Web client, wherein the first Web server issues the operation instruction on the basis of the operation instruction received from the Web client.

16. The method of controlling an image reader according to claim 15, comprising:
operating the image reader as a second Web server, wherein the second Web server displays control information received through the network and executes a control instruction.

17. A method of controlling an image reader according to claim 16, wherein the Web client displays Web pages supplied from the first Web server and the second Web server, and transmits a control instruction specified by the Web pages to the first Web server or the second Web server.
